(19) United States
(12) Patent Application Publication
(10) Pub. No.: US 2004/0245046 A1
(43) Pub. Date: Dec. 9, 2004

(54) Instantaneous evacuation tube

(76) Inventor: Alphonse Du Perron, Ste-Martine (CA)

Correspondence Address: ALPHONSE DUPERRON, 6210 Boulevard St-Michel #2, MTL, QC, HIY 2E7, CA

(21) Appl. No.: 10/718,296

(22) Filed: Nov. 21, 2003

(30) Foreign Application Priority Data
Jan. 30, 2003 (CA) 2,417,174

(51) Int. Cl. A62B 1/20

(52) U.S. Cl. 182/48

(57) ABSTRACT

The instantaneous evacuation tube is permanently installed at the exterior of the tower or building or integrated into it with an outside view, starting at the top and going down around the tower to the ground floor in a specific angle which permits the evacuated people when there is a fire to slide down at a normal speed and to avoid bodily injuries, each floor is equipped with an emergency exit and a hand lever accessible automatically to the compressed air tank, a movement detector with 2 small lights, 1 red and 1 green indicating if yes or no there's people at the interior of the tube clearly defined on my following “Literary appreciation” and on the ground floor an inflatable bed that permits the evacuated persons when arriving to the ground floor, sliding along the tube, to be stopped by the inflatable bed to be evacuated instantly. This is the best secure way to evacuate people as soon as possible when there is a fire or any dangerous event.

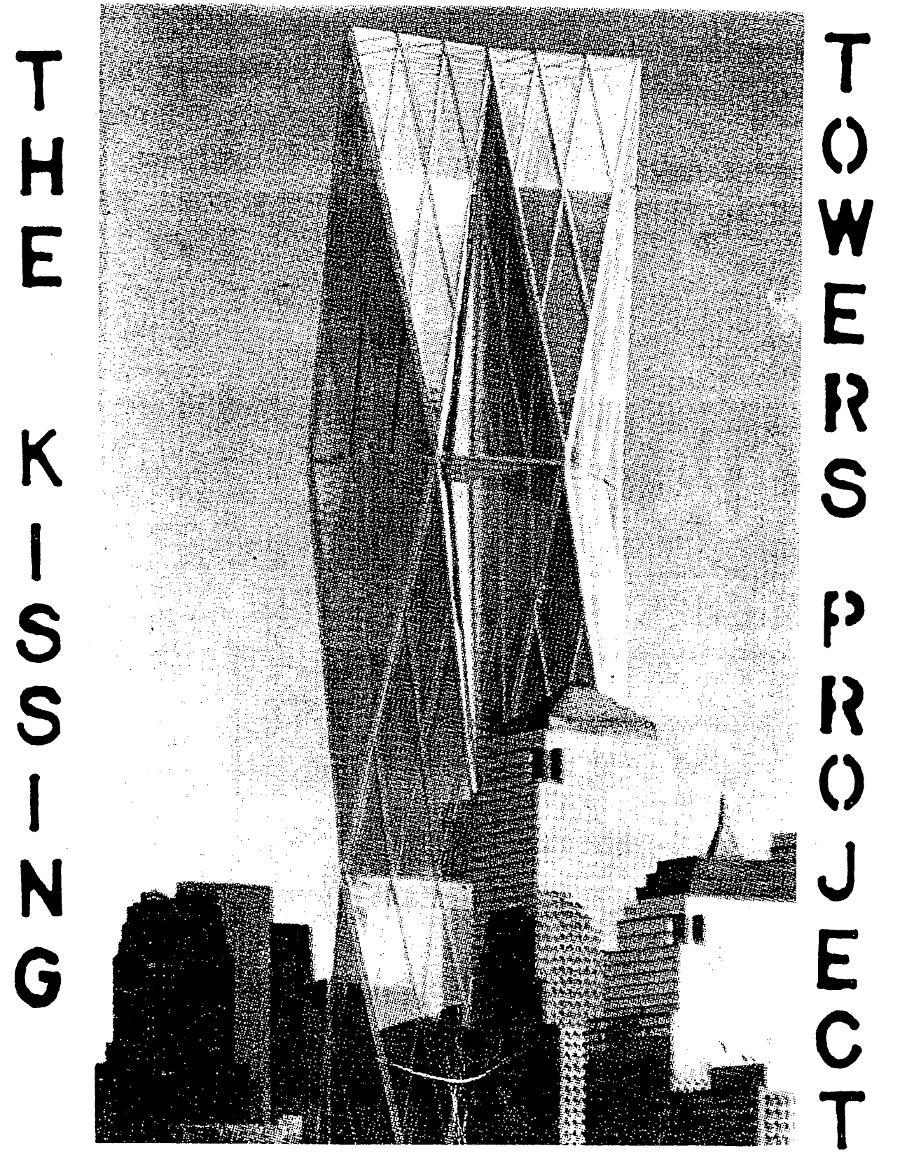

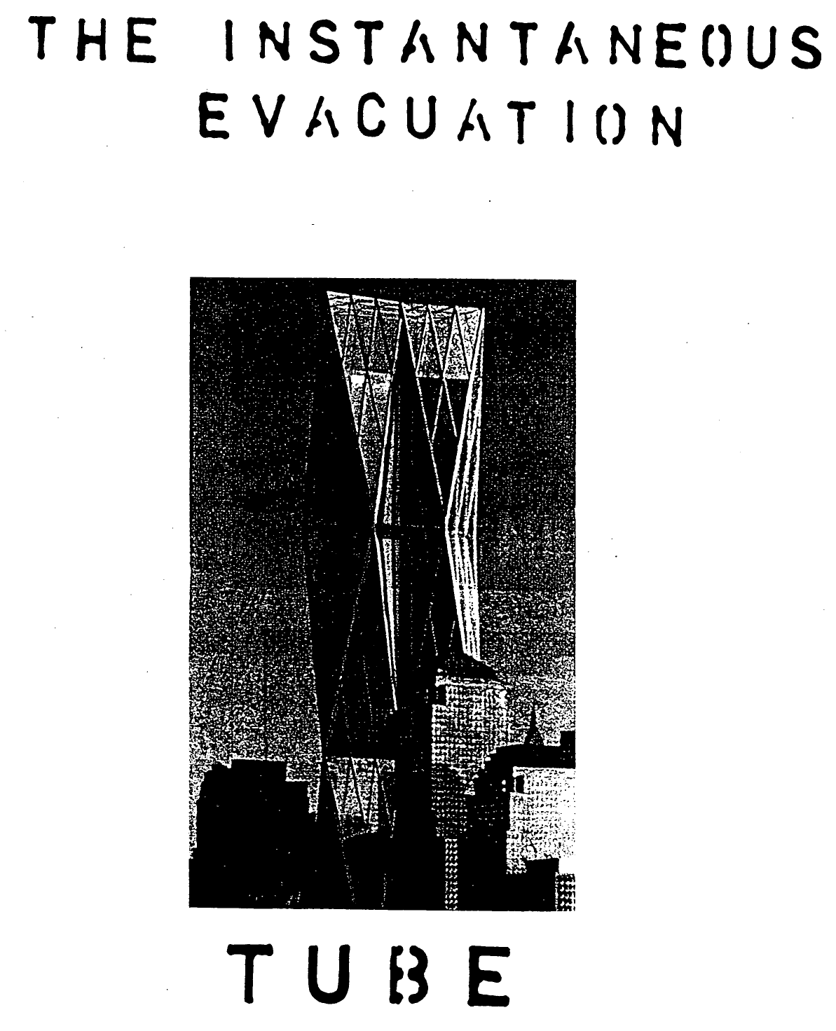

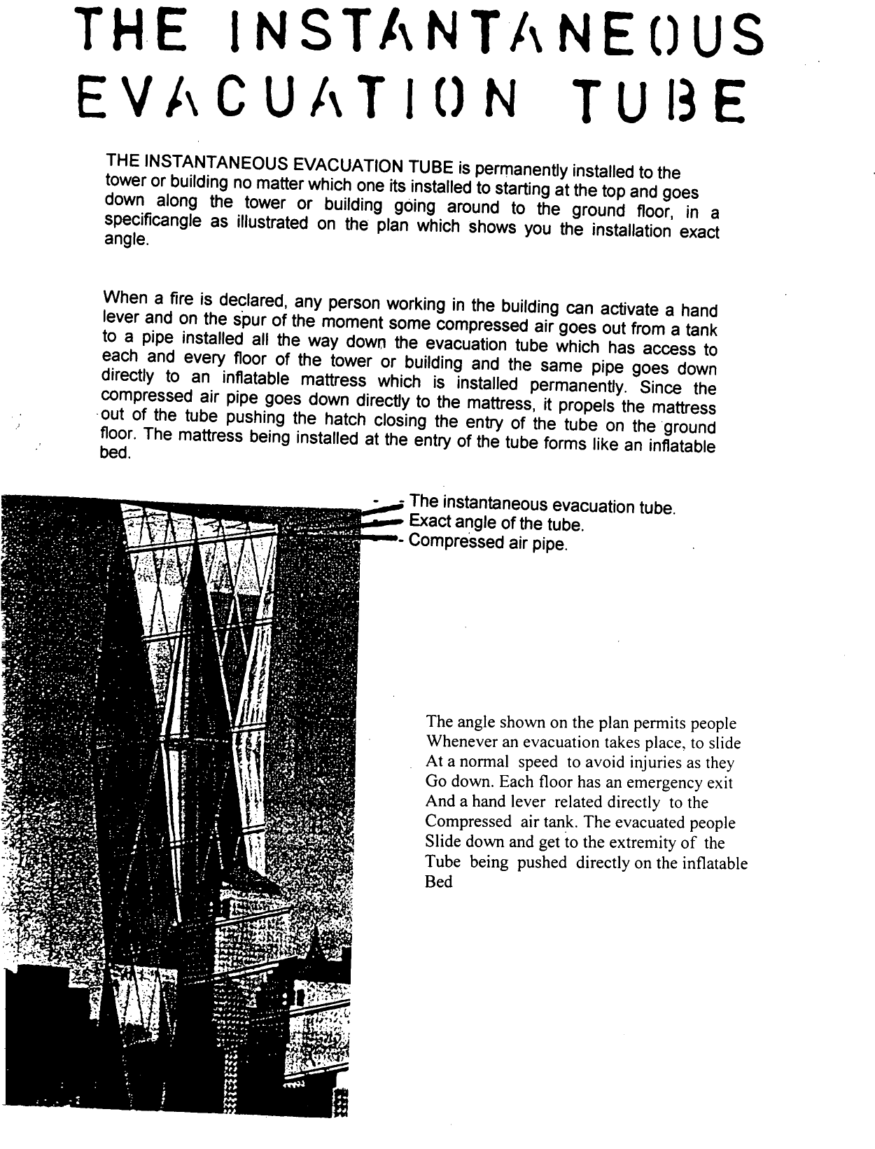

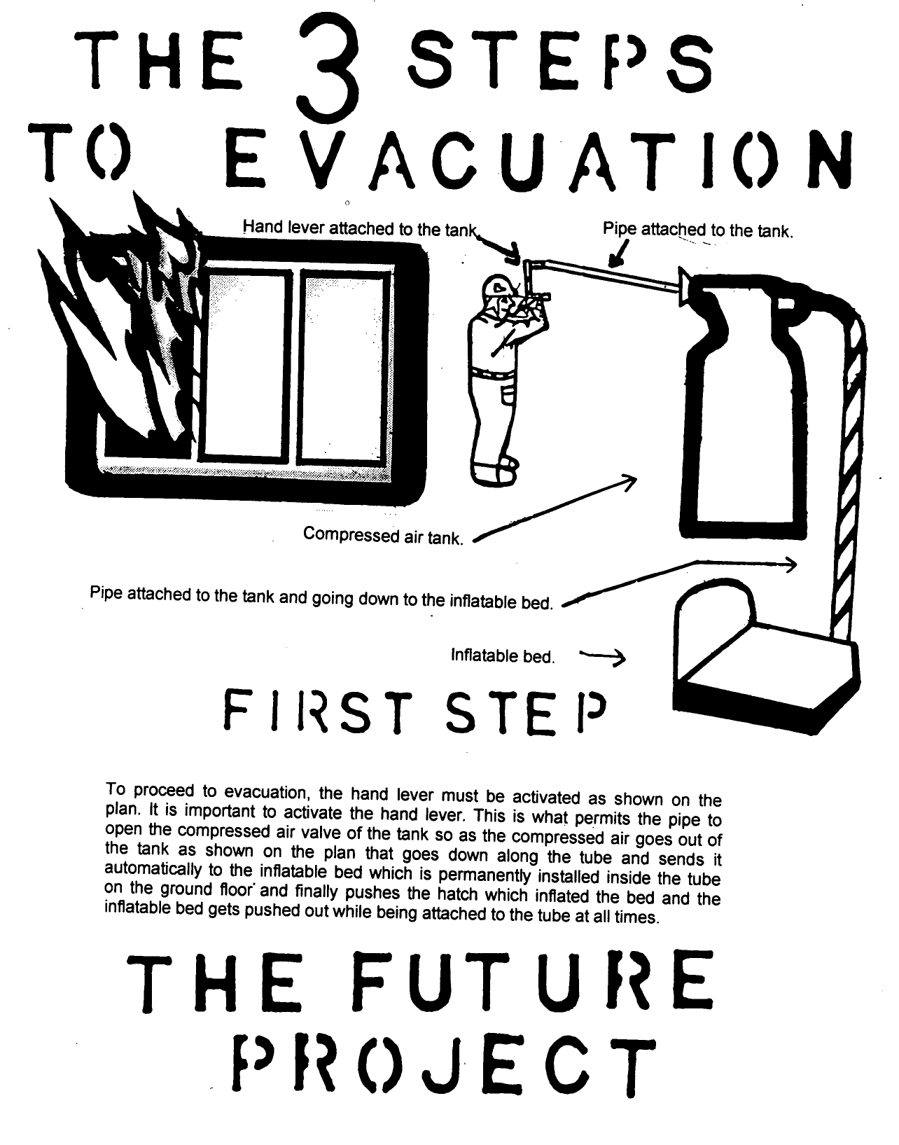

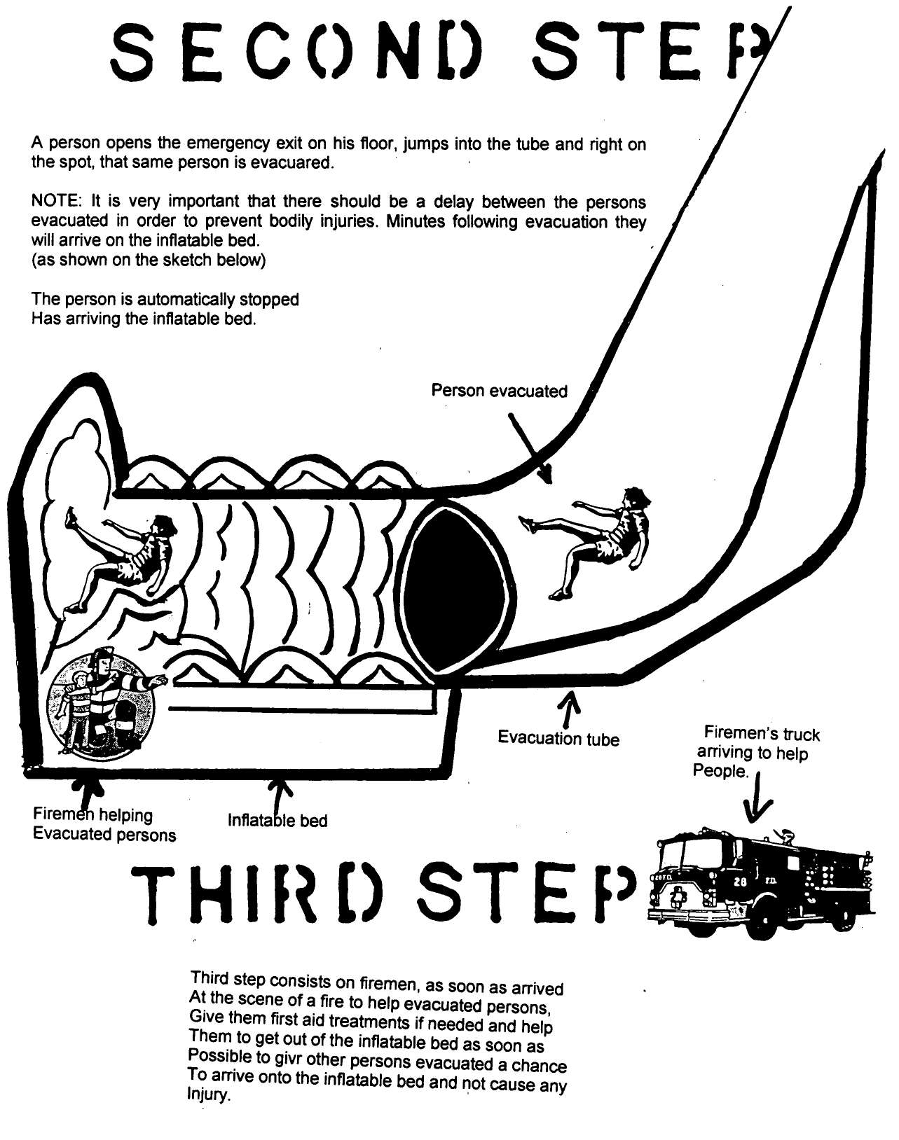

The advantages are that the first aid workers have the chance to catch people on the ground floor instead of going up a ladder to get them and risk their lives and those of others and it diminishes enormously the risks of morality.

THE INSTANTANEOUS EVACUATION TUBE is permanently installed to the tower or building no matter which one its installed to starting at the top and goes down along the tower or building going around to the ground floor, in a specific angle as illustrated on the plan which shows you the installation exact angle.

When a fire is declared, any person working in the building can active a hand lever and on the spur of the moment some compressed air goes out from a tank to a pipe installed all the way down the evacuation tube which has access to each and every floor of the tower or building and the same pipe goes down directly to an inflatable mattress which is installed permanently. Since the compressed air pipe goes down directly to the mattress, it propels the mattress out of the tube pushing the hatch closing the entry of the tube on the ground floor. The mattress being installed at the entry of the cube forms like an inflatable bed.

[image]

### BACKGROUND OF THE INVENTION

The background of the invention cannot be revealed because the invention is completely new.

### BRIEF SUMMARY OF THE INVENTION

The instantaneous evacuation tube is a very clever invention because it is only about slip by passing around of outside a tower or a building. There is much advantages, there is the speed of evacuation because the tube can have an urgently exit door on all the floors then the evacuation is done very quickly at the time of the fire. There is also ingeniousness because the tube pass around of outside the tower or the building (example) if the tower has 100 stages and that the fires is taken on the 80^{2nd} stage and that the fire progresses very quickly (let us specify that the fire goes always up to higher stages) then how to do to evacuate the peoples in the higher floors of the fire by helicopter, by elevator, no none of these ways is suitable. The best way with security at the time of the fire is the instantaneous evacuation tube because it is installed outside permanently what reckon on any eventuality during the evacuation while slipping you pass around the fire so this ways is the best and fast manner to evacuate people with security. Another advantage it is that the first-aid workers have the advantage of awaiting you at the ground floor because in bottom there is an inflatable bed of compressed-air. The big advantage is that the first-aid workers can wait you at the ground floor instead of rising up and to try to get you and finally risking their life to save another one.

THE 3 STEPS TO EVACUATION

[image]

### First Step

To proceed to evacuation, the hand lever must be activated as shown on the plan. It is important to activate the hand lever. This is what the pipe to open the compressed air valve of the tank so as the compressed air goes out of the tank as shown on the plan that goes down along the tube and sends it automatically to the inflatable bed which is permanently installed inside the tube on the ground floor and finally pushes the hatch which inflated the bed and the inflatable bed gets pushed out while being attached to the tube at all times.

### Second Step

A person opens the emergency exit of his floor, jumps into the tube and right on the spot, that same person is evacuated. NOTE: it is very important that there should be a delay between the persons evacuated in order to prevent bodily injuries. Minutes following evacuation they will arive on the inflatable bed. The person is automatically stopped has arriving the inflatable bed.

[image]

### Third Step

Third step consists on firemen, as soon as arrived at the scene of a fire to help evacuated persons, give them first aid treatments if needed and help them to get out of the inflatable bed as soon as possible to give other persons evacuated a chance to arrive onto the inflatable bed and not cause any injury.

### DETAILED DESCRIPTION OF THE INVENTION

The achievements of the invention on the subject of which an exclusive right of property or privilege is described as it follows. The tube of instantaneous evacuation is installed permanently outside any of a tower or building. The tube is installed starting from the top going down along the tower by passing around it to the ground floor making a specific angle so that the disaster victims can be evacuated at a normal speed to the ground floors. Trap doors with air are installed after the tube at each emergency exit to enable the air entering and to foresee smoke inside the tube if it is necessary. Each stage the tube has a trap door with air. The tube must be manufactured by a large rigid plastic to resist the bad weather (Example: the tube can be manufactured of a glass-wool which resists a very hot temperature and it does not burn). The tube must be also transparent to prevent the decreasing of vision fields of the people working inside the tower and in this manner we can see any evacuated person, thus, this solution envisages if there is a danger inside the tube or not. The mode of installation remains with the discretion of the engineer because the tube can be installed in a different way which is confirmed with the owner of the tower (Example: the tube can be embedded in the tower based on the construction of this one or can demand the modification of the tower to be able to make the embedding of the tube). The tube can also be installed using a gigantic crane in different section and so to fix it using a collar which should be screwed in the concrete of the tower but all that is confirmed with the owner of the tower in the manner of installation that he want. For the best way of the installation of tube is that, it should be always outside. The tube has detectors of movement, which are installed afier the tube at each stage extremity whenever there are one or more people inside the tube who are evacuated; the detector of movement sends the signal with the assistance of a magic eye. Two small lights are installed just at the top of each door of emergency exit for each stage. There are two small lights red and green, the red light indicates that you will not be able to be evacuated immediately because one or more person are currently passing in front of you, from one moment to another you must wait until the light pass to green, at this time you can be evacuate without any risk to make a collision with the other person. All that happen very quickly when there is a fire, a person actuates the lever and at this time the compressed air escapes from a tank and of a fraction of second sends the air in a pipe which is installed all along the tube automatically reaches all stages, a lever and tank are accessible on all stages. The pipe goes down in parallel along the tube while passing around the tower to the ground floor and this is connected directly to the inflatable bed. The inflatable bed is installed inside the tube permanently; the air that enters to the bed causes a compression what results that the bed is propelled outside the tube so pulverizing the cap closes the input of the tube. The bed is also attached to the end of the tube thus forming an inflatable bed. At the time of the descent each stage has a door of emergency exit and a lever connected directly to the tank. At the time of descent, the evacuated people slip and arrive at the end of the tube are propelled directly in the inflatable bed of compressed-air. The bed is located completely in the bottom at the end of the tube which had been actuated with the assistance of the lever thus causing an inflatable bed of compressed-air.

1. I ask for a claim concerning my invention having title ‘the instantaneous evacuation tube’.
